(19) United States
(12) Patent Application Publication
(10) Pub. No.: US 2001/0043142 A1
(43) Pub. Date: Nov. 22, 2001

(54) Vehicle back up alarm with integral back up light

(76) Inventor: Franklin L. Milliken, Concord, CA (US)

Correspondence Address: LARIVIERE, GRUBMAN & PAYNE, LLP, 1 LOWER RAGSDALE, BLDG. 1, SUITE 130, P.O. BOX 3140, MONTEREY, CA, 93942, US

(21) Appl. No.: 09/796,499

(22) Filed: Feb. 28, 2001

Related U.S. Application Data
(60) Provisional application No. 60/185,279, filed on Feb. 28, 2000.

(51) Int. Cl. B60Q 1/22

(52) U.S. Cl. 340/463; 340/464; 340/467

(57) ABSTRACT

A vehicle back-up alarm in combination with a vehicle back-up light in any of several embodiments: a single housing containing an alarm, a single housing containing an alarm and a light source, a single housing containing an alarm or other warning device and another sensor, or a housing containing a sensor and light. Included in the first combination is an alternative of a light adapted to be used with an existing vehicle alarm. Other embodiments comprise any combination of one or more of audible warning device, distance-sensing device, warning lights, video and/or audio systems, communication systems or other devices, lighting device, and a standard housing to contain them and mount to a vehicle without modification. The housing includes mounting aids such as resilient grommets or flanges with holes therein which are designed to match either a specific vehicle or a variety of vehicles, and further includes a housing adapted for a vehicle trailer hitch receiver. The associated wiring harness is terminated with a standard connector which allows the invention to be plugged into the existing vehicle wiring harness without modification, or a pigtail for splicing into the wiring harness.

### CROSS-REFERENCE TO RELATED APPLICATION

This non-provisional utility application is related to co-pending U.S. Provisional Application for Patent Serial No. 60/185,279, filed Feb. 28, 2000, entitled “Vehicle Back Up Alarm with Integral Back Up Light.”

### TECHNICAL FIELD OF THE INVENTION

The present invention pertains generally to vehicle operating alarms and lights, and more specifically, to commercial vehicles required by competent state or federal authority to have backup alarms which automatically operate to provide audible warning that a vehicle is moving rearward to its normal direction of travel.

### BACKGROUND ART

Back-up alarms are required on construction vehicles by the U.S. Occupational Safety and Health Administration (OSHA), on mining vehicles by the U.S. Mine Safety and Health Administration (MSHA) and on ambulances generally by Federal Contract “K” specifications. A number of states require back-up alarms on commercial vehicles. California (MVC 27,000) and Illinois require back-up alarms on garbage trucks. New York and Ohio require back-up alarms on school busses. Hawaii requires back-up alarms for delivery (e.g. UPS/FedEx) vehicles. Title 49 Code of Federal Regulations requires back-up lights on most classifications of over the highway trucks. Such alarms must meet published standards for sound emission levels. Back up alarms acceptable under the regulations are manufactured to meet the Society of Automotive Engineers standard, SAE J994b, for sound emission levels, among other requirements.

Back-up alarms are commonly attached to a motor vehicle by bolting the alarms to the frame or other body member in a rearward facing position. Back-up lights are normally installed as an integral part of the vehicle body or bumper. The inventor's prior invention, U.S. Pat. No. 4,994,800, is an exception as the alarms can now be mounted in a standard hole at the rear of the vehicle. FIGS. 1-3 of the drawing show prior art embodiments that must be specially mounted to a vehicle, not using the vehicle manufacturer's-provided recesses or mounting points.

All major truck lighting manufacturers build many models of back-up lights that are attached to the vehicle by way of screws, bolts or, as in the TruckLite Model 40, within a rubber grommet of the same kind that can be used to attach a back-up alarm covered under U.S. Pat. No. 4,994,800. Light sources are commonly protected from damage and dirt by transparent covers, which are frequently unsuitable for covering alarm devices due to sound absorption and distortion properties of the cover.

Back up alarms and lights receive power from a common source and are activated simultaneously. It would be most practical if they were collocated because there frequently are restrictions on space and suitable mounting points available at the rear of commercial vehicles. It is an object of the present invention therefore to provide a single unit warning and lighting device that can be efficiently manufactured and installed as a replacement for an existing light or alarm on a vehicle without requiring any structural modification of the vehicle.

Most pickup trucks and sport utility vehicles come factory equipped with a trailer hitch receiver. Although many of these vehicles are sold for commercial use, many are family vehicles. Most of the vehicles are used without a trailer hitch a good part of the time. Although back-up alarms may not be required for these vehicles, it would be desirable to install an alarm, without drilling holes or otherwise modifying the vehicle, by using the hitch receiver. It would be desirable, for example, to install an additional tail light, stop light, back-up light or other device in the hitch receiver. It is therefore a further object of the invention to provide a vehicle in motion warning alarm or/and light that fits without modification into the trailer hitch receiver.

### BRIEF DISCLOSURE OF THE INVENTION

The present invention relates generally to a vehicle in motion warning system such as a back-up alarm in combination with a vehicle back-up light, either a light alone or in combination with additional devices. The present invention can take any of several embodiments: a single housing containing an alarm and a light source, a single housing containing an alarm or warning device and another sensor, or a housing containing a sensor and light, a housing containing only one of the above devices, or a single housing containing any combination of three or more such devices. Included in the first combination is an alternative of a light adapted to be used with an existing vehicle alarm. The preferred embodiment consists of a single housing containing an audible alarm meeting published standards and a light. Other embodiments comprise any combination of two or more of an audible warning device, distance-sensing device, warning lights, video and/or audio systems, communication systems or other devices, lighting device, and a standard housing to contain them and mount to a vehicle without modification of either the device or the vehicle. Such mounting is contemplated to be in a vehicle's receptacle for a back up alarm or light, or a trailer hitch receiver.

One embodiment is a housing which is sized to match the standard mounting recesses of a vehicle such as an earth mover, commercial van or truck, or an emergency vehicle. The housing includes mounting means such as grommets or flanges with holes therein which are designed to match either a specific vehicle or a variety of vehicles. Mounted within the housing is an audible alarm source meeting all regulatory requirements and a light source, which are wired to operate together. The associated wiring harness is preferably terminated with a standard connector which allows the invention to be plugged into the existing vehicle wiring harness without modification. Alternatively, the wiring may be left unterminated and suitable for splicing into the vehicle wiring harness.

### BRIEF DESCRIPTION OF DRAWINGS

For fuller understanding of the present invention, reference is made to the accompanying drawing in the following detailed description of the Detailed Description of the Invention. In the drawings:

FIG. 1 shows one embodiment of the prior art.

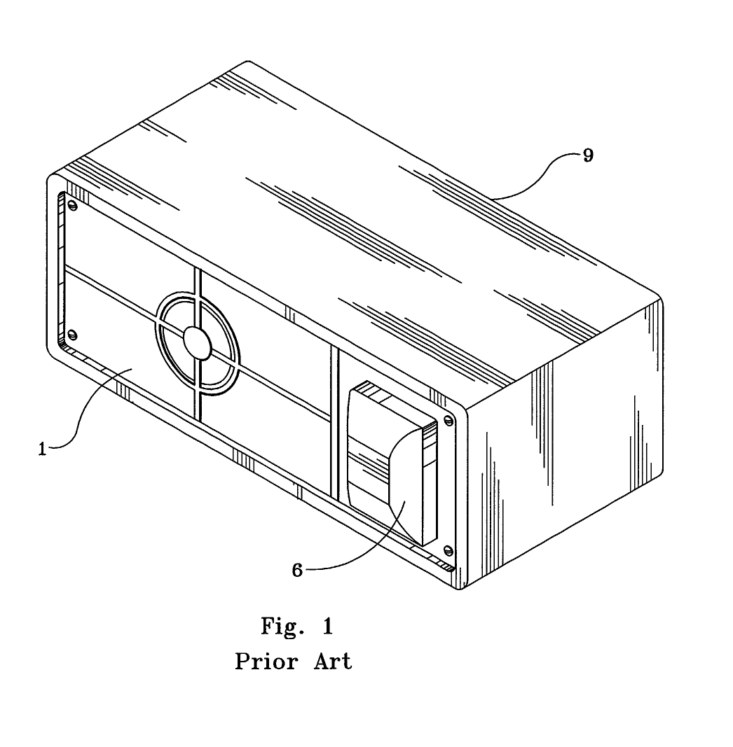

FIG. 2 shows a second embodiment of the prior art.

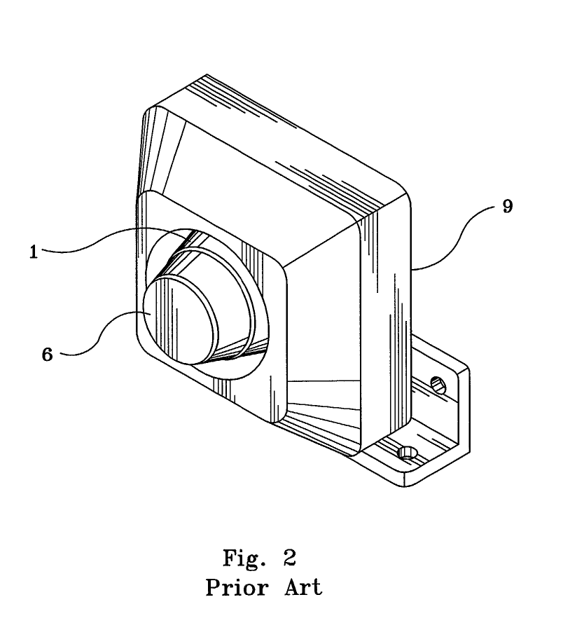

FIG. 3 shows a third embodiment of the prior art.

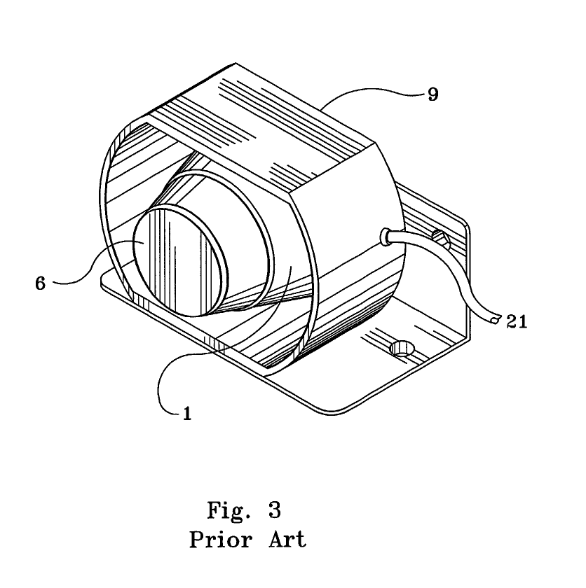

FIG. 4 shows three views of a preferred embodiment of the present invention.

FIG. 5 shows three views of a second embodiment of the present invention.

FIG. 6 shows a sectional view of the embodiment of FIG. 5.

FIG. 7 shows an embodiment adapted for use with a trailer hitch receiver.

Reference numbers refer to the same or equivalent parts of the present invention throughout the several figures of the drawings.

### DETAILED DESCRIPTION OF THE INVENTION

The present invention can take any of several embodiments: a single housing containing an alarm, a single housing containing an alarm and having an associated light source affixed, a single housing containing an alarm or warning device and another sensor, a housing containing a sensor and light, or an alarm with two or more additional devices as identified below. Included in the first combination is an alternative of a light adapted to be used with an existing vehicle alarm. The preferred form is a housing which is sized to match the standard 4.5 inch (11.44 centimeters) mounting recesses of a vehicle such as an earth mover, commercial van or truck, or an emergency vehicle, and having a combination of warning device and lighting device. The housing includes a mounting means or aid such as a resilient grommet or flanges with holes therein which are designed to match either a specific vehicle or a variety of vehicles. An alternative housing form is adapted to fit into either a two inch or one and one-half inch standard vehicle trailer hitch receiver, with either an included means for securing the housing to the receiver or a separate locking device. Mounted within the housing is an audible alarm source or an audible alarm source and a light source which are wired to operate together. The associated wiring harness is preferably terminated with a standard connector which allows the invention to be plugged into the existing vehicle wiring harness without modification. Alternatively, the wiring may be left as an unterminated pigtail suitable for splicing into the vehicle wiring harness.

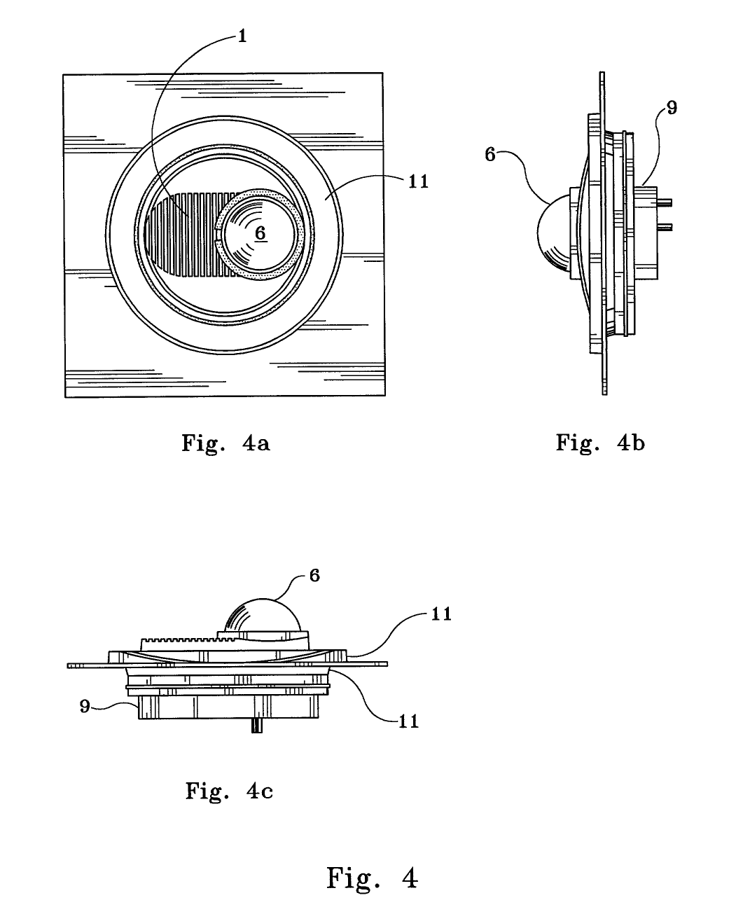

Referring now to FIG. 4, three views of a preferred embodiment of the present invention are shown. FIG. 4A is a frontal view, and in reference to 4A, 4B is a right edge-on view and 4C is a bottom edge-on view. Housing 9 is shaped to fit into a standard vehicle light or alarm receptacle by aid of resilient grommet 11. Housing 9 may be either round, as shown, oval, rectangular, or any required shape suitable for the desired application. Housing 9 contains a back up alarm 1 such as any available in the market. Alarm 1 may be one or more, used in combination, of any type of warning device such as an audible sound generator. Audible sound generators are commonly used as back up alarms. Placed within the housing but within only a portion thereof, is light source 6. Light source 6 may consist of a conventional incandescent lamp as is known in the art or a brighter light source such as a strobe light, halogen lights or perhaps light emitting diodes. In the embodiment adapted for use with a vehicle trailer hitch receiver, light source 6 could include a stop light.

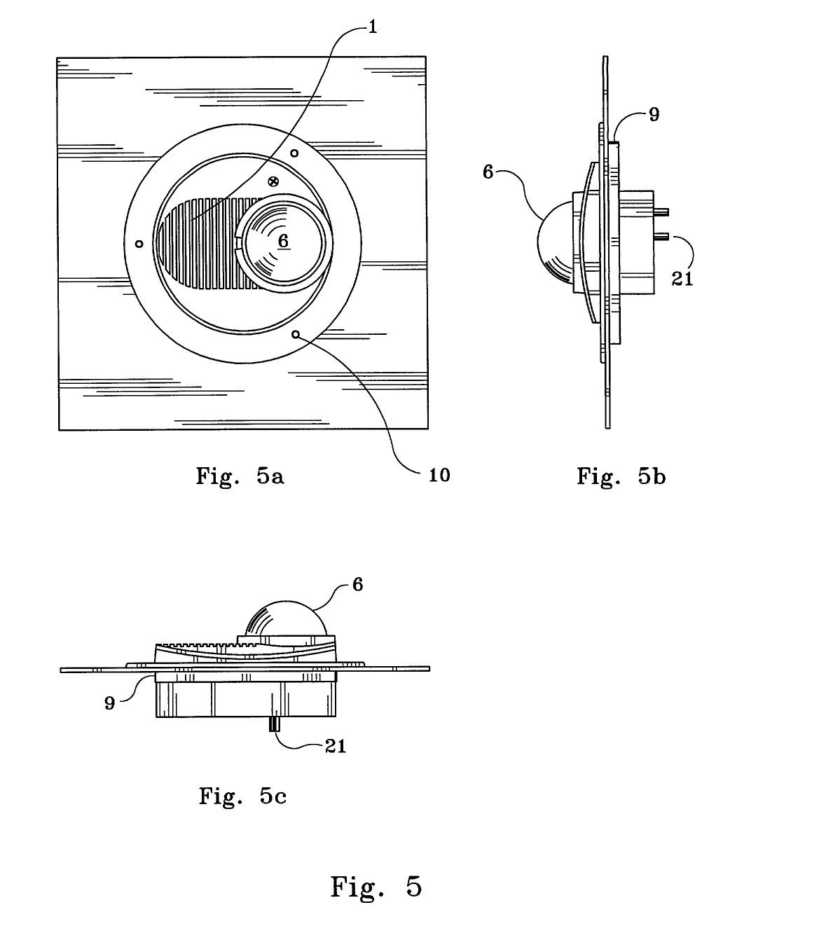

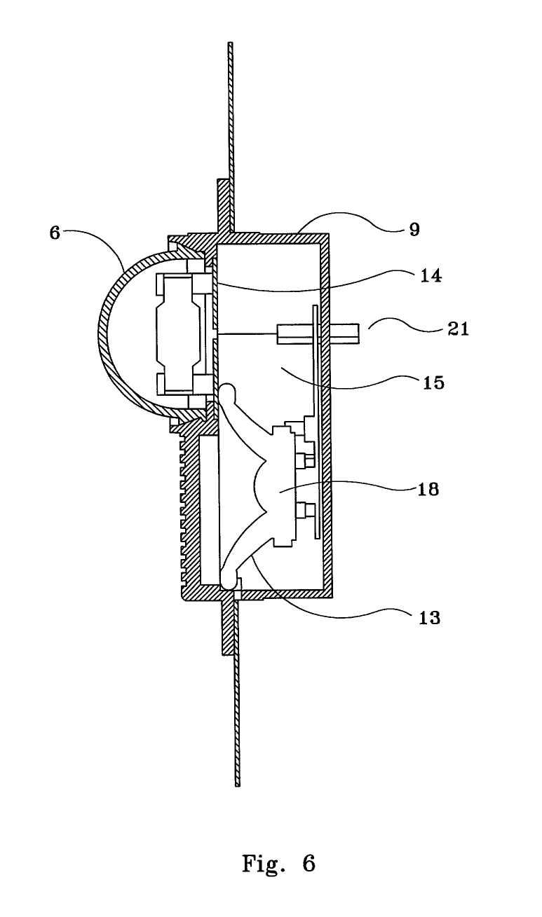

Referring now to FIGS. 5 and 6, a second embodiment of the present invention is shown. FIG. 5 shows three views of this embodiment; 5A is a frontal view, 5A is a right edge-on view, and 5C is a lower edge-on view. Alarm 1 may be any model of warning device. Fitted in front of alarm 1 is light 6. Again, light 6 may be of any convenient type for the configuration desired. Light 6 may be affixed adhesively to alarm 1. Housing 9 is adapted to be affixed within the appropriate vehicle recess by fasteners passing through apertures 10. Electrical connection 21 is adapted to plug into the vehicle wiring harness in this figure.

Alarm 1 is typically made in the manner of an audio speaker or driver with a speaker cone 13 which serves to amplify the sound generated by an electronic printed circuit board and associated electronics 18. Membrane 14 is a metal or composite member which forms a chamber 15 in conjunction with housing 9, separating the speaker/driver from the associated light 6. Electrical wires 21 lead to the vehicle wiring harness and ground as desired. Wires 21 may be either terminated in a plug suitable for the vehicle wiring harness or left unterminated, suitable for splicing into the vehicle wiring.

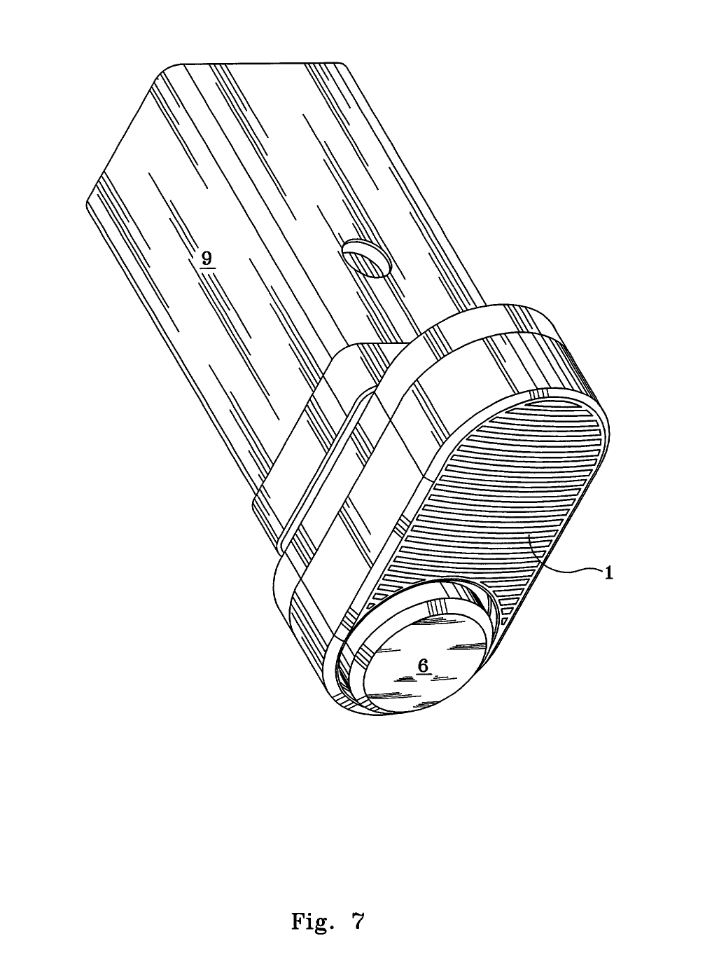

FIG. 7 shows the present invention in an embodiment with a housing 9 adapted to fit into a vehicle trailer hitch receiver (not shown). While a combination of alarm 1 and light 6 is shown, it is to be understood that either the alarm 1 or the light 6 could be removed, replaced with a different device, or augmented with an additional device or devices.

In a second embodiment of the invention, light 6 may be replaced or augmented with a sensor. The type of sensor is limited only by current technology. For example, a television camera, an audio detector such as a microphone or other sound-sensing device, a visual warning generator, or an object sensing device. A small sound-sensor and associated speaker could be employed, allowing the vehicle operator to both listen for persons or activities behind or near the vehicle, as well as to either manually or automatically broadcast an audible warning. Current technology allows for miniaturized televison cameras, perhaps fitted with a wide-angle lens, that can be fitted into a suitable housing. Such a camera would be associated with a television monitor at the vehicle operator's station, providing an enhanced view of the area behind or near the vehicle. Other technologies for sensing devices useful for warning the operator of someone behind or near the vehicle include proximity radar, doppler radar, sonar, ultra sound ranging, ultraviolet or infrared sensors and microwave sensors for example. In this embodiment, alarm 1 could also be replaced with or augmented by some other alarming device.

Other forms of alarms than audible alarms include visual warning devices consisting of incandescent lights, perhaps colored red, blue or yellow for example, strobe lights; halogen lights and light emitting diodes, for example. These visual warning devices could be made to provide either a fixed or steady light such as a stop light, or a flashing warning.

In a third embodiment of the invention, alarm 1 may be replaced with a sensor and used in conjunction with light 6. The technologies contemplated for both sensor and lights are described above. Further, it is understood that, while the present invention has been described in terms of a vehicle backing-up system, it is readily adaptable for forward motion of many vehicles, as well as other warning requirements such as raising or lowering of dump truck bodies, aerial or man lifts, garbage packers, movement of stabilizing outriggers, and the like.

It is also to be understood that the electrical power source to operate the devices associated with the invention is the vehicle electrical system. Associated with the typical vehicle reverse gear is normally a switch that turns on power to the back up alarm or light receptacle when the reverse gear is engaged. This automatically provides power to the present invention. An additional power source from the vehicle electrical system may be provided through an operator-accessible switch or key-switch to power some or all of the invention combination as desired, whether or not the vehicle is in motion or the engine is turned off. For example, a switch could be provided to power the audio speaker so that the operator could issue verbal directions to persons near the vehicle. Any and all such combinations of powering the individual devices described herein are contemplated by and included within the present invention.

Information as herein shown and described in detail is fully capable of attaining the above-described object of the invention, the presently preferred embodiment of the invention, and is, thus, representative of the subject matter which is broadly contemplated by the present invention. The scope of the present invention fully encompasses other embodiments which may become obvious to those skilled in the art, and is to be limited, accordingly, by nothing other than the appended claims, wherein reference to an element in the singular is not intended to mean “one and only one” unless explicitly so stated, but rather “one or more”. All structural and functional equivalents to the elements of the above-described preferred embodiment and additional embodiments that are known to those of ordinary skill in the art are hereby expressly incorporated by reference and are intended to be encompassed by the present claims.

Moreover, no requirement exists for a device or method to address each and every problem sought to be resolved by the present invention, for such to be encompassed by the present claims. Furthermore, no element, component, or method step in the present disclosure is intended to be dedicated to the public regardless of whether the element, component, or method step is explicitly recited in the claims. However, it should be readily apparent to those of ordinary skill in the art that various changes and modifications in form, material, and fabrication detail may be made without departing from the spirit and scope of the inventions as set forth in the appended claims. No claim herein is to be construed under the provisions of 35 U.S.C. 112, sixth paragraph, unless the element is expressly recited using the phrase “means for”.

What is claimed is:

1. A vehicle motion warning apparatus comprising:
a warning means;
a light-emitting means;
a mounting means for securing the device to a vehicle; and
electrical connection between the apparatus and the vehicle wiring harness.

2. The apparatus of claim 1 wherein the warning means and the light emitting means are both associated with a housing.

3. The apparatus of claim 1 wherein the warning means is selected from the group consisting of audible means, television camera, visual means, object sensing means.

4. The apparatus of claim 3 wherein the audible means is selected from the group consisting of sound generating electronic circuits, audio detectors and speakers.

5. The apparatus of claim 3 wherein the visual means is selected from the group consisting of incandescent lamps, strobe lights, flashing halogen lamps, steady halogen lamps, light emitting diodes.

6. The apparatus of claim 3 wherein the object sensing means is selected from the group consisting of proximity radar, doppler radar, sonar, ultra sound, ultra violet sensors, infrared sensors, microwave sensors.

7. The apparatus of claim 3 wherein the television camera is connected with a television display in the vehicle operator's area of the vehicle.

8. The apparatus of claim 2 wherein the housing is sized to fit without modification in a commercial vehicle back up alarm or light housing.

9. The apparatus of claim 2 wherein the housing is adapted to fit into a trailer hitch receiver.

10. The apparatus of claim 9 wherein the mounting means includes a locking means.

11. A vehicle motion warning device comprising a light means adapted to fit on to an audible alarm warning device.

12. The device of claim 11 wherein the light means is selected from the group consisting of incandescent lamps, strobe lights, flashing halogen lamps, steady halogen lamps, light emitting diodes.

13. A vehicle motion warning apparatus comprising:
a housing having mounting means adapted to commercial vehicles and having an electrical connection suitable for mating with the vehicle electrical light wiring harness;
a warning means; and
a light means.

14. The apparatus of claim 13 wherein the warning means is selected from the group consisting of audible means, television camera connected with a television display in the vehicle operator's area of the vehicle, visual means, object sensing means.

15. The apparatus of claim 14 wherein the audible means is selected from the group consisting of sound generating electronic circuits, audio detectors, and audio speakers.

16. The apparatus of claim 14 wherein the visual means is selected from the group consisting of flashing incandescent lamps, strobe lights, flashing halogen lamps, steady halogen lamps, light emitting diodes.

17. The apparatus of claim 14 wherein the object sensing means is selected from the group consisting of proximity radar, doppler radar, sonar, ultra sound, ultra violet sensors, infrared sensors, microwave sensors.

18. The apparatus of claim 13 wherein the mounting means is adapted to fit into a trailer hitch receiver.

19. A vehicle motion warning apparatus comprising:
a warning means, and
a mounting means for securing the apparatus to a vehicle trailer hitch receiver.

20. The apparatus of claim 19 wherein the warning means is selected from the group consisting of audible means, television camera, visual means, object sensing means.
